(19) United States
(12) Patent Application Publication
(10) Pub. No.: US 2007/0143241 A1
(43) Pub. Date: Jun. 21, 2007

(54) Field supported user interface for feature limited computing devices

(75) Inventors: Frank M. Israel, Mannheim (DE); Jan Matthes, Darmstadt (DE)

Correspondence Address: KENYON & KENYON LLP, 1500 K STREET N.W., WASHINGTON, DC, 20005, US

(73) Assignee: SAP AG

(21) Appl. No.: 11/300,422

(22) Filed: Dec. 15, 2005

(51) Int. Cl. G06F 17/30

(52) U.S. Cl. 707/1

(57) ABSTRACT

A user interface is provided for a feature limited mobile device that provides a field delimited prompt for data. The user interface displays truncated field prompts that identify input data. When input data is assembled, the mobile device generates a character delimited query string and transmits it to an enterprise service. A query response from the enterprise service is displayed on the mobile device.

### BACKGROUND

The present invention provides a user interface for input-limited mobile devices that permit operators of the mobile device to input queries to enterprise management applications in a convenient manner.

Modern businesses typically use computer networks and applications (collectively, enterprise services) to manage their day-to-day operations. Product manufacturers, among other things, use enterprise services to manage customer relations and sales, to monitor product inventory, to manage manufacturing and vendor supply chains and to arrange for product shipping. These manufacturers increasingly use feature-rich mobile computing platforms such as laptop computers, tablet computers and robust personal digital assistants to permit their employees to run queries of enterprise data from remote locations in real time. Such features are particularly useful when, for example, a manufacturer salesperson meets personally with a client at the client's location and the client requests real time confirmation that the manufacturer can fulfill a prospective product order.

As noted, laptop computers, tablet computer and personal digital assistants are feature rich. They typically include a robust set of user interface devices to permit operators to enter and manage a wide variety of user data rapidly. A typical laptop computer may have an 88-key keyboard, which permits an operator to enter freestyle text with ease. Similarly, these feature rich devices typically include large displays that permit a wide variety of complex user interfaces such as are provided in HTML pages.

Notwithstanding the advantages of such feature rich devices, they have not achieved widespread use in all countries of the world due to their relatively high cost. For example, they currently are considered cost-prohibitive in many countries of Asia and Africa. Despite these limitations, salespersons in these countries still require real time access to enterprise services and the underlying data. Salespeople in such countries typically attempt to access enterprise services using limited feature set computing devices such as mobile phones, which have display sizes typically less than 2″×2″ or less than 200 pixels by 200 pixels and have less than 15 keys for data input.

Using a mobile phone, a salesperson may generate a short message service (SMS) message which includes a query to an enterprise service defined according a character delineated string of input data. One such example is illustrated in FIG. 2 where the query string represents a query as shown in Table 1:

TABLE 1

| QUERY FIELD | QUERY DATA |
|---|---|
| Query Type | 3 |
| Salesperson ID | 1797 |
| Customer ID | S6342 |
| Product ID | 11884477701 |
| Quantity | 125 |
| Delivery Date | 01/03/2007 |

This means of querying an enterprise service is cumbersome because it requires an operator to memorize the fields that must be entered into the SMS query and the order in which the fields must be entered. During the ordinary course of a salesperson's job, the salesperson may run perhaps a dozen or more different types of queries to an enterprise service, each of which must be memorized to be performed effectively. This communication protocol, therefore, is vulnerable to human error.

Accordingly, there is a need in the art for a user interface in a feature limited mobile communication device that assists operators to generate and submit SMS queries to an enterprise service.

### BRIEF DESCRIPTION OF THE DRAWINGS

FIG. 1 is a simplified diagram of a network suitable for use with the present invention.

FIG. 2 illustrates a known user interface for generating SMS queries.

FIG. 3 illustrates a user interface for a feature limited mobile communication device according to an embodiment of the present invention.

FIG. 4 illustrates an alternate user interface for a feature limited mobile communication device according to an embodiment of the present invention.

FIG. 5 illustrates a control architecture of a feature limited mobile communication device according to an embodiment of the present invention.

### DETAILED DESCRIPTION

Embodiments of the present invention provide a user interface for a feature limited mobile device that provides a field delimited prompt for data. The user interface displays truncated field prompts that identify input data. When input data is assembled, the mobile device generates a delimited query and transmits it to an enterprise service. A query response from the enterprise service is displayed on the mobile device.

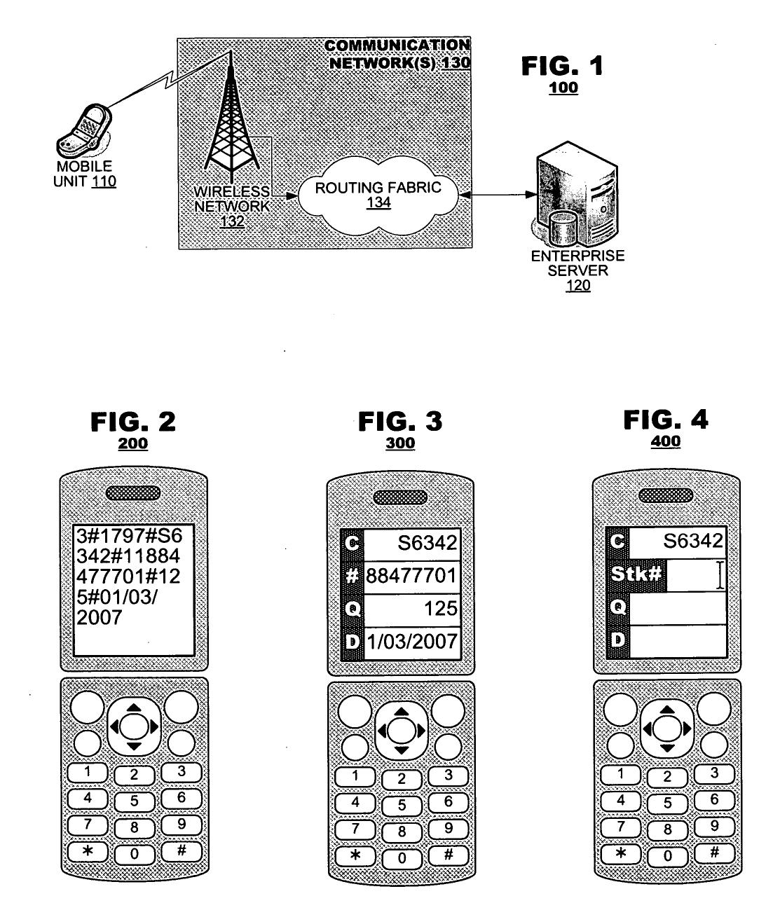

FIG. 1 is a simplified block diagram of a network 100 suitable for use with the present invention. The network 100 may include a mobile unit 110 and an enterprise server 120 provided in mutual communication by a communication network 130. The communication network may include a wireless communication component 132 and a routing fabric component 134. The wireless communication component 132 may exchange radio frequency (RF) signals with the mobile unit 110. The routing component 134 may direct communications received by the wireless network to the enterprise server 120 and vice versa. Although the wireless component and routing component are illustrated in FIG. 1 as discrete components, they need not be provided as such. Conventionally, wireless communication carriers include communication routers and other wireline apparatus to route data between their mobile subscribers and other communication apparatus. Similarly, some data networking companies may employ various RF communication apparatus at their discretion to carry data along their network. For the purposes of the present discussion, it is sufficient to note that communication infrastructure can establish communications between the mobile unit 110 and the server 120 via RF communications.

An operator of the mobile unit 110 may generate a query of the server 120 via a user interface of the present invention. When the operator commands the mobile unit 110 to send the query to the server 120, the mobile unit 110 generates a message and communicates the message to the communication network 130 via a wireless communication protocol. Various messaging formats are available. For example, the message may be an SMS message, a multimedia message service (MMS) message or an e-mail message. The communication network 130 forwards the message to the enterprise server 120 where it is parsed and executed. The enterprise server 120 may generate a query response, which is transmitted back to the mobile unit 110 via the communication network 130. The mobile unit 110 may display the response on a display.

FIG. 3 illustrates an exemplary user interface of the mobile unit 110 according to an embodiment of the present invention. As noted, the mobile unit 110 has a limited display area for data queries. According to an embodiment, the user interface presents a field limited display of typical queries in which each input field is identified by a limited identified, typically a single character or truncated character indicator. The example of FIG. 3 identifies four input fields that might be displayed to permit an operator to check product availability: customer identifier, stock number, quantity and delivery date. Owing to the limited display area of the mobile unit's display, the field prompts are shown as a single character—“C” for customer identifier, “#” for stock number, “Q” for quantity and “D” for delivery date. An operator may use the input keys to navigate a cursor among the fields and enter or amend parameter data. Upon completion of the query data, the operator may command the mobile unit to format a query therefrom and transmit it to the server.

The principles of the foregoing embodiments may be integrated with other navigation aids for user interfaces. For example, if the number of fields to a query exceeds a number that can be displayed simultaneously on a display, the user interface may permit scrolling through the fields to permit an operator to enter all necessary data. Additionally, the user interface may distribute field prompts across pages of information. In this manner, an operator may enter all appropriate data for a query even though the data cannot be accommodated on a single screen of the display.

According to an embodiment of the present invention, the user interface may dynamically expand a field prompt if an operator has difficulty determining what kind of information is being sought by the prompt. FIG. 4, for example, illustrates an expanded stock quote prompt over the illustration of FIG. 3. In this embodiment, the field prompt has expanded over a single character prompt to display a multiple character prompt that unambiguously identifies the type of information sought for the corresponding field.

According to an embodiment, expansion of a field prompt may be triggered by user navigation to a corresponding field followed by a period of inactivity. The user interface may provide a cursor that indicates a point of the display on which new operator input will be entered. If an operator places the cursor in an empty field and then leaves the cursor in the field for a predetermined period of time without entering data therein, the user interface may display an expanded form of a field prompt therefor to identify the information being sought. Once an operator begins to enter data in the field or if the operator navigates the cursor away from the corresponding field, the user interface may return the field prompt to its default, truncated form.

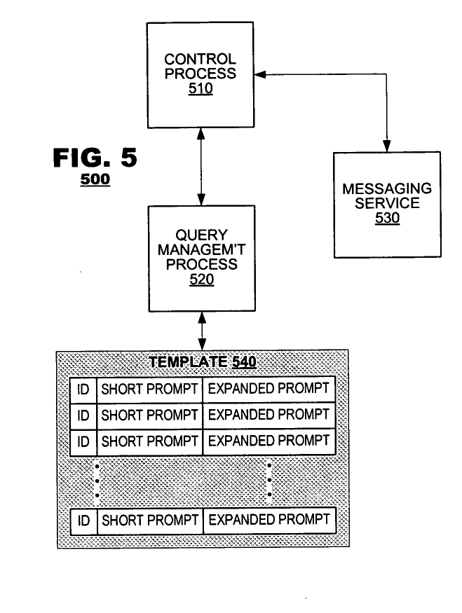

FIG. 5 is a functional block diagram of software processes of a mobile unit according to an embodiment of the present invention. As illustrated in FIG. 5, the processes may include a control process 510, a query management process 520 and a messaging service 530. The control process 510 represents overall management of the mobile unit, which integrates a variety of services offered by modern mobile phones under a common control architecture. The messaging service 530 is one of these services—it may manage generation of outgoing message traffic and incoming message traffic. For outgoing message traffic, the messaging service 530 typically accepts user input via a user interface, formats the message according to communication protocols that are appropriate to the communication network in which the mobile unit resides and transmits the message to the communication network. For incoming message traffic received from the communication network, the messaging service parses the message and stores it for access by the mobile unit's operator.

The query management process 520 is a service that facilitates collection of query data from mobile unit operators. The query management process 520 may be supported by a variety of templates 540 that are specific to each kind of query to be performed (only one such template is illustrated in FIG. 5). Each template 540 may specify a number of input fields to be collected from an operator, definitions of short prompts and expanded prompts to be displayed via the user interface and an identifier that defines an order in which field data shall be inserted into a communication message to the server.

When the query management process 520 is invoked, the process 520 may present an introductory menu from which an operator selects an appropriate query. The process 520 then generates field prompts according to the definitions provided in a corresponding template 540. Once an operator indicates to the mobile unit that the query data is complete, the process 520 may pass the query data to the messaging service 530 using the same protocol as is used when an operator enters messaging data directly to the messaging service and causes it to generate an outgoing message. Thus, the present invention provides an elegant user interface to an operator without requiring any alteration to the performance of the messaging service 530.

The principles of the present invention may be extended to other applications beyond queries of enterprise services. For example, one may provide predefined user interfaces on mobile devices of IT professionals to permit them to run remote diagnostics of computer networks. Such queries would be delivered to the networks and responses returned to the mobile devices. In such an embodiment, the predefined user interfaces may be supplemented with an option to permit the IT professional to enter command line prompts at the mobile device, which would be delivered to and executed by the computer network.

Several embodiments of the present invention are specifically illustrated and described herein. For example, while the invention has been described as operating on a mobile phone, it also finds application with other feature-limited devices such as personal digital assistants (including Blackberry-style PDAs), pagers and the like. However, it will be appreciated that modifications and variations of the present invention are covered by the above teachings and within the purview of the appended claims without departing from the spirit and intended scope of the invention.

We claim:

1. A method for querying an enterprise service from a feature-limited mobile device, comprising:
displaying field prompts from a query template on a display of the mobile device,
upon command, generating a delimited message from input data entered with respect to the field prompts,
transmitting the message, and
displaying on the mobile device results received in response to the message.

2. The method of claim 1, wherein the template is stored locally on the mobile device.

3. The method of claim 1, further comprising retrieving the field prompts in response to a query selection entered with respect to a menu of available queries.

4. The method of claim 1, wherein the message is a character delimited string of text.

5. The method of claim 1, wherein the message addresses an enterprise server.

6. The method of claim 1, wherein the message is an SMS message.

7. The method of claim 1, wherein the message is an MMS message.

8. The method of claim 1, wherein the message is an e-mail message.

9. The method of claim 1, wherein the mobile device is a cellular phone.

10. The method of claim 1, wherein the mobile device is a pager.

11. The method of claim 1, wherein the mobile device is a personal digital assistant.

12. The method of claim 1, wherein the mobile device possess fewer than 20 data input keys.

13. The method of claim 1, wherein the mobile device possesses a display of fewer than 200×200 pixels.

14. A user interface for input-limited mobile devices, comprising:
a plurality of input fields distributed across a graphical user interface,
a plurality of prompts, each prompt providing a truncated identified of input field data for a corresponding input field, wherein in response to navigation to one of the fields the user interface displays a corresponding prompt in an expanded mode.

15. The user interface of claim 14, displayed on a display device having an area less than four square inches.

16. The user interface of claim 14, displayed on a display device having display size less than four thousand pixels.

17. The user interface of claim 14, wherein the mobile device generates an SMS message as a character delimited string of text.

18. The method of claim 17, wherein the SMS message addresses an enterprise server.

19. The user interface of claim 14 provided within a mobile device that is a cellular phone.

20. The user interface of claim 14 provided within a mobile device that is a pager.

21. A method for querying computer network from a feature-limited mobile device, comprising:
displaying field prompts from a query template on a display of the mobile device,
upon command, generating a delimited message from input data entered with respect to the field prompts,
transmitting the message, and
displaying on the mobile device results received in response to the message.

22. The method of claim 21, further comprising displaying a command line prompt on the display of the mobile device.

23. The method of claim 21, wherein the field prompts relate to IT diagnostics.
